(19) United States
(12) Patent Application Publication
(10) Pub. No.: US 2023/0314151 A1
(43) Pub. Date: Oct. 5, 2023

(54) ECONOMY DRIVING ADVICE SYSTEM

(71) Applicant: GM GLOBAL TECHNOLOGY OPERATIONS LLC, Detroit, MI (US)

(72) Inventors: Daniel Urieli, Herzliya (IL); Klaus Trangbaek, Ein Vered (IL); Vladimir Suplin, Modiin (IL); Omer Zerbib, Kfar Saba (IL)

(73) Assignee: GM GLOBAL TECHNOLOGY OPERATIONS LLC, Detroit, MI (US)

(21) Appl. No.: 17/713,476

(22) Filed: Apr. 5, 2022

(51) Int. Cl. G01C 21/34; G07C 5/02

(52) U.S. Cl. CPC G01C 21/3469; G07C 5/02

(57) ABSTRACT

An economy advisory system includes a circuit and a display. The circuit is configured to receive a route plan remainder of a vehicle and receive a plurality of consumption factor values of the vehicle while the vehicle traverses the route plan. The plurality of consumption factor values is controllable by a driver of the vehicle. The circuit is further configured to modify the plurality of consumption factor values based upon a plurality of modification factor values, calculate a plurality of potential range changes of the vehicle based on the route plan remainder and the plurality of consumption factor values as modified, and identify a group that has at least one of the plurality of potential range changes and a corresponding at least one of the plurality of modification factor values. The display is in communication with the circuit and is configured to present the group to the driver.

### INTRODUCTION

The present disclosure relates to a system and a method for providing economy driving advice to a driver of a vehicle.

Current vehicle energy saving technologies predict energy consumption per planned routes and present the driver with multiple optional routes, each with a corresponding driving time and energy consumption/savings. Currently the available options are general in nature, for example, which route to take and reminders to brake gently.

Accordingly, those skilled in the art continue with research and development efforts in the field of economy driving advice that is specific to actual driving conditions, quantitative, and given in real-time.

### SUMMARY

An economy advisory system is provided herein. The economy advisory system includes a circuit and a display. The circuit is configured to receive a remainder of a route plan of a vehicle, and receive a plurality of consumption factor values of the vehicle while the vehicle traverses the route plan. The plurality of consumption factor values is controllable by a driver of the vehicle. The circuit is further configured to modify the plurality of consumption factor values based upon a plurality of modification factor values, calculate a plurality of potential range changes of the vehicle based on the remainder of the route plan and the plurality of consumption factor values as modified, and identify a group that has at least one of the plurality of potential range changes and a corresponding at least one of the plurality of modification factor values. The display is in communication with the circuit, and is configured to present the group to the driver.

In one or more embodiments of the economy advisory system, the circuit is further configured to store the plurality of potential range changes and the plurality of modification factor values in a table prior to the identification of the group.

In one or more embodiments of the economy advisory system, the circuit is further configured to sort the plurality of potential range changes in the table from a furthest potential range change to a shortest potential range change. The group is identified as a predetermined number of the plurality of potential range changes as sorted that starts with the furthest potential range change.

In one or more embodiments of the economy advisory system, the circuit is further configured to repeat periodically in an inner cycle the modification of the plurality of consumption factor values, and the calculation of the plurality of potential range changes.

In one or more embodiments of the economy advisory system, a first subset of the plurality of consumption factor values is modified and a second subset of the plurality of potential range changes is calculated in a single one of a plurality of passes through the inner cycle.

In one or more embodiments of the economy advisory system, the circuit is further configured to repeat periodically in an outer cycle the reception of the remainder of the route plan and the plurality of consumption factor values and, the modification of the plurality of consumption factor values, and the identification of the group.

In one or more embodiments of the economy advisory system, the circuit is further configured to calculate a current range of the vehicle based on the route plan and the plurality of consumption factor values as measured. The group is identified as the plurality of potential range changes that increases the current range.

In one or more embodiments of the economy advisory system, the route plan is a plurality of possible route plans. The calculation of the plurality of potential range changes of the vehicle is based on the plurality of possible route plans and the plurality of consumption factor values as modified.

In one or more embodiments of the economy advisory system, the plurality of consumption factor values includes one or more of a speed, an acceleration, a deceleration, a heating-ventilation-and-air conditioning set point, a tire pressure, a window position, and a weight of the vehicle.

A method for economy driving advice is provided herein. The method includes receiving a remainder of a route plan of a vehicle at a circuit, and measuring a plurality of consumption factor values of the vehicle while the vehicle traverses the route plan. The plurality of consumption factor values is controllable by a driver of the vehicle. The method further includes modifying the plurality of consumption factor values based upon a plurality of modification factor values, calculating a plurality of potential range changes of the vehicle based on the remainder of the route plan and the plurality of consumption factor values as modified, identifying a group that has at least one of the plurality of potential range changes and a corresponding at least one of the plurality of modification factor values, and presenting the group to the driver at a display.

In one or more embodiments, the method includes storing the plurality of potential range changes and the plurality of modification factor values in a table prior to the identifying of the group.

In one or more embodiments, the method includes sorting the plurality of potential range changes in the table from a furthest potential range change to a shortest potential range change. The group is identified as a predetermined number of the plurality of potential range changes as sorted that starts with the furthest potential range change.

In one or more embodiments, the method includes repeating periodically in an inner cycle the modifying of the plurality of consumption factor values, and the calculating of the plurality of potential range changes.

In one or more embodiments of the method, a first subset of the plurality of consumption factor values is modified and a second subset of the plurality of potential range changes is calculated in a single one of a plurality of passes through the inner cycle.

In one or more embodiments, the method includes repeating periodically in an outer cycle the receiving of the remainder of the route plan, the measuring of the plurality of consumption factor values, the modifying of the plurality of consumption factor values, and the identifying of the group.

In one or more embodiments, the method includes calculating a current range of the vehicle based on the route plan and the plurality of consumption factor values as measured. The group is identified as the plurality of potential range changes that increases the current range.

In one or more embodiments of the method, the route plan is a plurality of possible route plans, and the calculating of the plurality of potential range changes of the vehicle is based on the plurality of possible route plans and the plurality of consumption factor values as modified.

A vehicle is provided herein. The vehicle includes a plurality of sensors, a circuit, and a display. The plurality of sensors is configured to measure a plurality of consumption factor values of the vehicle. The plurality of consumption factor values is controllable by a driver of the vehicle. The circuit is in communication with the plurality of sensors, and is configured to receive a remainder of a route plan of the vehicle, receive the plurality of consumption factor values while the vehicle traverses the route plan, modify the plurality of consumption factor values based upon a plurality of modification factor values, calculate a plurality of potential range changes of the vehicle based on the remainder of the route plan and the plurality of consumption factor values as modified, and identify a group that has at least one of the plurality of potential range changes and a corresponding at least one of the plurality of modification factor values. The display is in communication with the circuit, and is configured to present the group to the driver.

In one or more embodiments of the vehicle, the circuit is further configured to sort the plurality of potential range changes from a furthest potential range change to a shortest potential range change. The group is identified as a predetermined number of the plurality of potential range changes as sorted that starts with the furthest potential range change.

In one or more embodiments of the vehicle, the circuit is further configured to calculate a current range of the vehicle based on the route plan and the plurality of consumption factor values as measured. The group is identified as the plurality of potential range changes that increases the current range.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram illustrating a context of a vehicle in accordance with one or more exemplary embodiments.

FIG. 2 is a functional flow diagram of an advisory system in accordance with one or more exemplary embodiments.

FIG. 3 is a schematic diagram of a route plan screen and an advice screen on a display in accordance with one or more exemplary embodiments.

FIG. 4 is a schematic block diagram of the advisory system in accordance with one or more exemplary embodiments.

FIG. 5 is a flow diagram of a method for generating economy driving advice in accordance with one or more exemplary embodiments.

FIG. 6 is a flow diagram of a first sorted table population step in accordance with one or more exemplary embodiments.

FIG. 7 is a flow diagram of a second sorted table population step in accordance with one or more exemplary embodiments.

FIG. 8 is a flow diagram of a group identification step in accordance with one or more exemplary embodiments.

### DETAILED DESCRIPTION

Vehicle energy consumption depends on a variety of factors. Some factors may be detected during a drive and subsequently acted upon by a driver to achieve improved driving efficiency. Examples of such factors are driving behavior (e.g., speed, accelerations and decelerations), heating-ventilation-and-air conditioning (HVAC) set points, tire pressure, window status, vehicle weight, an amount of fuel in a gas tank and a rate of fuel consumption (for internal combustion engines), a state of charge in a rechargeable energy storage system (e.g., vehicle battery pack) and a current draw (for hybrid engines and electric engines), weather, and other consumptions that limit the driving range of the vehicle prior to a refueling and/or a recharging stop. Example embodiments of the disclosure generally provide a system and method for generating driving advice that instructs the driver of one or more actions to improve a driving range of the vehicle during a trip. The advice may be selected and implemented by the driver or ignored. The advice is based on one or more route plans and the various factors related to vehicle dynamics and driving style. Various embodiments generally provide real-time in-drive feedback to the driver in the form of specific actions that the driver may take, or ignore, and potential energy savings in the form of possible maximum range changes for the vehicle and/or energy savings in kilowatt hours.

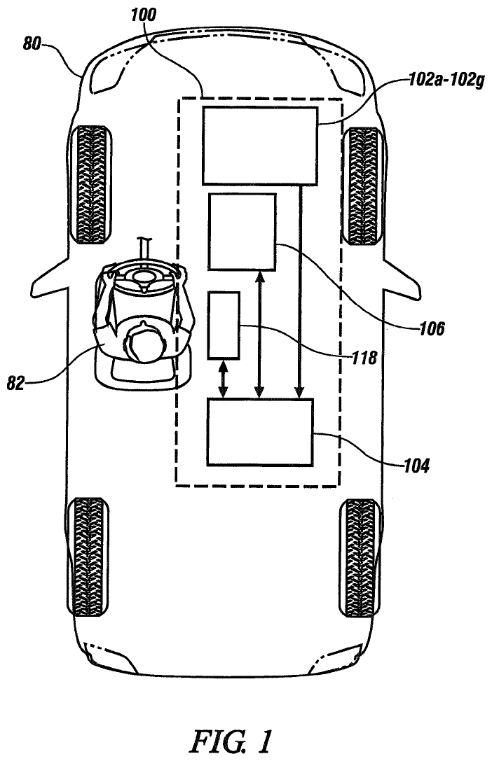

Referring to FIG. 1, a schematic plan diagram illustrating a context of a vehicle 80 is shown in accordance with one or more exemplary embodiments. The vehicle 80 may be occupied by a driver 82. An advisory system 100 is mounted to or carried in the vehicle 80. The advisory system 100 generally includes multiple sensors 102a-102g, a circuit 104, and infotainment system 106 and/or a handheld device 118.

The vehicle 80 implements an automobile (or car). In various embodiments, the vehicle 80 may include, but is not limited to, a passenger vehicle, a truck, an autonomous vehicle, a gas-powered vehicle, an electric-powered vehicle, a hybrid vehicle, a motorcycle, a boat, a farm vehicle, a train and/or an aircraft. The vehicle 80 defines a crew cabin in which the driver 82 resides while driving. The crew cabin may also accommodate one or more passengers.

The driver 82 may be a user of the vehicle 80. The driver 82 manually controls a variety of functions of the vehicle 80. In various embodiments, the driver 82 may control steering, acceleration, braking (deceleration), heating-ventilation-and-air conditioning set points, tire pressure, window positions, vehicle weight, and gear selection by entering manual commands into various driver controls. Visual graphic presentations that advise how to efficiently operate and configure the vehicle 80 are generated by the infotainment system 106 and/or the handheld device 118 for viewing by the driver 82. Other vehicle functions may be controlled by the driver 82 and/or other graphical presentations may be generated to meet the design criteria of a particular application.

The advisory system 100 implements a driver advice system. The advisory system 100 combines information accessed through onboard computing with a vehicle energy predictor to quantify and propose energy saving actions to the driver 82. The advisory system 100 is operational to detect energy saving opportunities, quantifies the factors that alter the energy consumption, and communicates the factors and potential range changes to the driver 82 in a non-intrusive manner, using a user-friendly energy saving display in the infotainment system 106 and/or an application running in the handheld device 118.

The sensors 102a-102g implement a variety of vehicle sensors. The sensors 102a-102g are operational to measure consumption factor values (measured values). The consumption factor values may include vehicle speed, acceleration, deceleration, heating-ventilation-and-air conditioning set points, tire pressure, window positions, vehicle weight, and gear selection. The sensors 102a-102g generally report the consumption factor values to the circuit 104.

The circuit 104 implements one or more processing circuits and one or more memory circuits. The circuit 104 is in communication with the sensors 102a-102g to receive the measured values. The circuit 104 is in communication with the infotainment system 106 to present the advice. Where the handheld device 118 is included in the advisory system 100, the circuit 104 may establish bidirectional wireless or wired communications with the handheld device 118. The circuit 104 is operational to receive a route plan and a remainder of the route plan of the vehicle 80 from the infotainment system 106 or the handheld device 118, receive the consumption factor values from the sensors 102a-102g, modify the consumption factor values with modification factor values, calculate potential range changes of the vehicle based on the route plan and the modified consumption factor values, identify a group that has one or more potential range changes and a corresponding one or more of the modification factor values, generate and present an advice screen to the infotainment system 106 and/or the handheld device 118.

The processing circuitry is capable of processing electronic instructions, and memory circuitry. The processing circuitry includes microprocessors, microcontrollers, host processors, controllers, vehicle communication processors, and application specific integrated circuits (ASICs). The processing circuitry executes diverse types of digitally-stored instructions, such as software programs and/or firmware programs stored in the memory circuitry. The memory circuitry implements one or more storage devices. The memory circuitry includes nonvolatile and volatile computer readable memory.

The infotainment system 106 implements a human machine interface configured to present information to the driver 82, and optionally the passengers within the vehicle 80, and receive inputs from the driver 82 and/or the passengers. The infotainment system 106 may include processing circuitry, one or more of displays, one or more speakers, one or more microphones, and multiple buttons. The infotainment system 106 is operational to provide information-related services such as onboard video camera images, vehicle features, music, web pages, movies, television programs, video games, navigation information (e.g., one or more route plans and route plan remainders), the advisory screen, and the like. Visual information generated by the infotainment system 106 may be presented via the display. Audio information generated by the infotainment system 106 may be presented via the speakers. Manual user inputs may be received from the driver 82 and the passengers via the buttons.

In various embodiments, the handheld device 118 implements a smart telephone, a tablet, a laptop computer, a notebook, or other similar device capable of bidirectional communication with the circuit 104. The handheld device 118 is operational to receive inputs from the driver 82, present information to the driver 82, store data, and process data. In various embodiments, the handheld device 118 may generate the route plans and the route plan remainders and display the advice screen. In some designs, the handheld device 118 may be programmed to perform the functionality of the circuit 104 to process the route plans and consumption factor values to generate the driving advice.

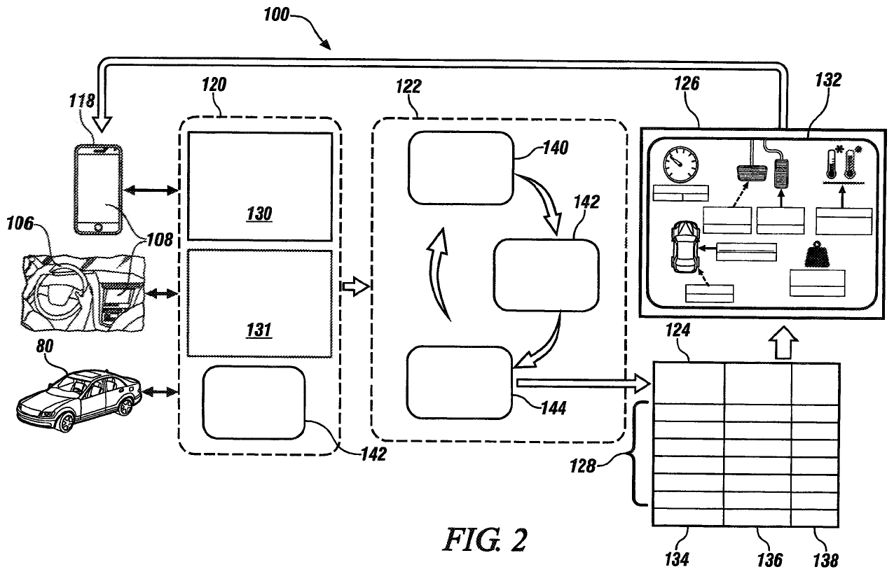

Referring to FIG. 2, a functional flow diagram of an example implementation of the advisory system 100 is shown in accordance with one or more exemplary embodiments. Functions of the advisory system 100 generally include an input block 120, an iteration block 122, a sorted table 124, and a presentation block 126. In some embodiments, the input block 120 may be partially implemented in the infotainment system 106 and partially implemented in the circuit 104. The iteration block 122 and the sorted table 124 are implemented in the circuit 104. The presentation block 126 is implemented in the infotainment system 106. In other embodiments, the input block 120 may be partially implemented in the handheld device 118 and partially implemented in the circuit 104. The iteration block 122, the sorted table 124 and the presentation block 126 are implemented in the handheld device 118. Other divisions of the functionality may be implemented to meet the design criteria of a particular application.

In the input block 120, the infotainment system 106 or the handheld device 118 may receive manual user inputs from the driver 82 to establish a starting location and an ending location for a trip. A route plan 130 may be generated in infotainment system 106 or the handheld device 118 by a mapping application. The route plan 130 may provide one or more available routes and sometimes suggest a particular route plan that has a lowest predicted trip energy consumption and/or avoids heavy traffic. A graphical representation of the route plan 130 is subsequently presented to the driver 82 by the display 108 of either the infotainment system 106 or the handheld device 118. A consumption factors block 131 determines driver controllable consumption factor values for use by the circuit 104. The consumption factor values may include parameters that affect vehicle energy consumption. The consumption factor values include recent (e.g., past) values of the parameters, such as recent speeds, recent accelerations, recent decelerations, and the like. The consumption factor values may include current values, such as HVAC set points, outside temperature, vehicle weight, tire pressure, window status, and the like.

The circuit 104 may execute an energy prediction model 142 using the one or more routes and the consumption factor values received from the sensors 102a-102g (see FIG. 1) as input data. The energy prediction model 142 generates a predicted energy consumption for the rest of the trip, or possible per the segments of the trip.

In some embodiments, the route plan may be entered through the mapping application that is in communication with the circuit 104. For example, the mapping application may be physically connected (e.g., wired) or wirelessly linked to the circuit 104 as part of the infotainment system 106. In another example, the mapping application may be embedded in the handheld device 118 and either plugged into or wirelessly linked to the circuit 104. Circuitry and components of a mobile application generally available to those skilled in the art may be employed.

The energy prediction model 142 is adapted to predict a driving energy or primary energy consumed for purposes of moving the vehicle 80 (e.g., consumed by a hybrid engine) and energy consumption by the vehicle 80 for non-propulsion or auxiliary purposes. A driving style is modeled to predict the speed of the vehicle 80 based in part on traffic conditions that may include, for example, live traffic data, peak hours, holidays, downstream traffic congestion level, road type, weather conditions and other factors. In some embodiments, the energy prediction model 142 may be personalized for each driver. The energy prediction model 142 may also calculate predicted consumption factor values of the parameters. The predicted consumption factor values generally include items such as predicted driver behavior, predicted average vehicle speed for each trip segment, predicted energy consumption, predicted auxiliary consumption (e.g., battery thermal conditioning), predicted driving consumption, and the like. An example implementation of the energy prediction model 142 may be found in co-pending U.S. application Ser. No. 17/590,019, filed Feb. 1, 2022, which is hereby incorporated by reference in its entirety.

The iteration block 122 provides an iterative “what-if” analysis that repeatedly modifies the consumption factor values, calls the trip energy consumption predictor with the modified factor values, write the results to the sorted table 124. The what-if analysis involves altering the consumption factor values with modification factor values in a modification block 140. The consumption factor values may be altered by applying (e.g., adding or multiplying) the modification factor values to the consumption factor values. The application may be one modification factor value at a time, multiple modification factor values concurrently, or every modification factor value concurrently. The modification factor values may have finite ranges (e.g., ±2 percent, ±4 percent, ±6 percent, etc.), or finite states (e.g., close the windows, enable regeneration braking, etc.). Some consumption factor values may be adjusted by multiple modification factor values (e.g., several HVAC set points, several speed adjustments both positive and negative). Each consumption factor value has an associated textual suggestion.

One or several modification factor values may be applied during each periodic cycle through the iterative block 122. For example, modification of the recent speed may be modified to several speeds, higher and lower than the current speed, (e.g., [v_min, v_min+5, v_min_+10, . . . ,v_max], where v_min is half of min(current_speed, speed_limit) and v_max is a speed_limit).

To modify recent accelerations, discrete acceleration to a few levels (e.g., low=0.5 meters/second², medium=1.5 meters/second², high=2.5 meters/second²) are applied. Future accelerations may be modified to lower levels. The same may be done with the number of accelerations per kilometer (e.g., low=0, medium=1, high=2 and up) that increase speed by more than a threshold (e.g., 10 kilometers/hour) if a speed of the vehicle 80 is more than a “jam” threshold (e.g., 25 kilometers/hour).

Recent decelerations may be handled similar to the acceleration levels with a preceding minus sign and number. Furthermore, if recent decelerations used mechanical brakes, the modification may be to use regeneration braking.

The current HVAC set point may be modified to several set points between current and the outside temperature (e.g., if the current set point is 23° Celsius and the outside temperature is 30° Celsius, utilize the following set points [24, 25, 26, 27, 28, 29, 30]).

For the vehicle weight, if an unusual overweight condition is detected, modify weight to several points between the current weight and a usual weight. For example, suppose the normal weight for n passengers is w_n, with standard deviation of s_n, and the current weight is larger than w_n+2×s_n, utilize weights such as [w_n, w_n+s_n].

If low pressure is detected, the tire pressure may be modified with several points between a minimum pressure and a maximum pressure, (e.g., if a minimum pressure=170 pounds per square inch (PSI), and a maximum pressure is =230 PSI, utilize [170, 180, 190, 200, 210, 220, 230]).

If one or more of the windows are not closed, the window status may be set to recommend closure.

The modified consumption factor values, route plans, and trip energy consumption prediction are received by the energy prediction model 142. The energy prediction model 142 calculates the affect the modifications have on potential energy consumption changes and potential range changes. The consumption factor values (column) 134, the modification factor values (column 136), and the potential range changes (column 138) are stored in the sorted table 124. Respective modification advice items represent the modification factor values in alphanumeric characters that are understandable by the driver 82. The consumption factor values, the modification advice items/modification factor values, and the potential range changes are arranged within the sorted table 124 from a furthest potential range change to a shortest potential range change. While many modification factor values result in positive potential range changes that increase a current range of the vehicle 80 if implemented by the driver 82, in some situations, the shortest potent range changes have negative values and thus may reduce the current range of the vehicle 80 if implemented.

In some situations, the driver 82 may desire to see a group 128 of a few highest-affect modification factor values that would best increase the current range of the vehicle 80. Therefore, only a predetermined number (e.g., 2 to 5) of the sorted potential range changes may be read from the sorted table 124 starting with the furthest potential range change. In other situations, the driver 82 may desire the group 128 to include only beneficial modification factor values that would increase the current range. Such beneficial modification factor values are subsequently read from the sorted table 124. Thus, only the modification factor values associated with positive potential range changes and presented to the driver 82. In still other situations, the entire contents of the sorted table 124 may be displayed to the driver 82. For example, the driver 82 may wonder how much range may be lost if a window is opened and thus wants to see even detrimental modification factor values.

In the presentation block 126, the circuit 104 or the handheld device 118 may populate an advice screen 132 with the consumption factor values, the modification advice corresponding to the modification factor values, and the potential range changes read from the sorted table 124. The advice screen 132 may summarize the most impactful actions from the sorted table 124 table in a convenient, interpretable way. The advice screen 132 is presented on a display 108 of the infotainment system 106 or the handheld device 118 to advise the driver 82 of the available actions and the potential outcomes.

Optional extensions may be implemented in the advisory system 100. For example, a personalized mode may be used for collecting history and/or statistics on each driver 82 for improving future rides. The advice screen 132 may include a destination context of “destination in range” and “destination out of range” as appropriate. The economy/sport mode of the vehicle 80 may be taken into consideration. For hybrid and electric vehicles, the energy consumption to precondition the vehicle battery may be considered when planning to charge. Furthermore, the advisory system 100 may be provided with route selection options (e.g., shorter, slower, more efficient route recommendations) for the driver 82 to consider.

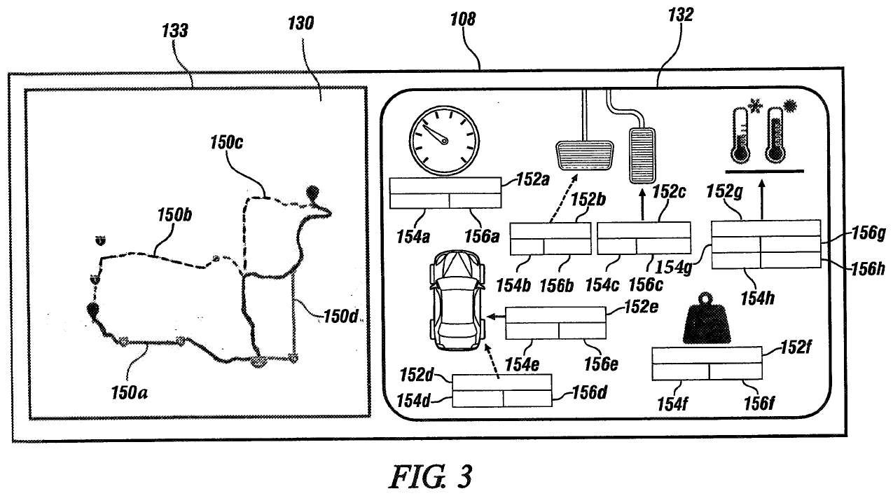

Referring to FIG. 3, a schematic diagram of an example implementation of a route plan screen 133 and the advice screen 132 on a display 108 is shown in accordance with one or more exemplary embodiments. The route plan screen 133 and the advice screen 132 are presented to the driver 82 from the display 108 (of either the infotainment system 106 or the handheld device 118). The route plan screen 133 may include multiple route plans 150a-150d. The route plan 150a may be considered the current route plan that the driver 82 should follow to complete the trip. The possible route plans 150b-150d may be considered alternative route plans that would also complete the trip.

The advice screen 132 may illustrate one or more of the consumption factor values 152a-152g, corresponding one or more modification advise items/modification factor values 154a-154h, and corresponding one or more potential range changes 156a-156h. In the example shown in the figure, a speed consumption factor value 152a may have a single advice/modification factor value 154a (slow by 15 kilometers/hour) and a potential range improvement 156a should the modification factor 154a be acted upon by the driver 82. An acceleration consumption factor value 152b may have a modification factor value 154b (e.g., a “Mild” modification advice) and a potential range change 156b. A deceleration consumption factor value 152c may have an advice/modification factor value (e.g., regeneration braking) 154c and a potential range change 156c. A tire pressure consumption factor value 152d shows a modification factor value 154d (e.g., an “Inflate” modification advice) with a corresponding potential range change 156d. The window position consumption factor value 152e has a single modification factor value 154e (e.g., a “Close” modification advice), resulting in a potential range change 156e. A weight consumption factor value 152f of the vehicle may have a modification factor value 154f (e.g., reduce the weight by 10 kilograms) to achieve a potential range change 156f (e.g., +2 km). An HVAC set point consumption factor value 152g may have a first advice/modification factor value 154g with a first potential range change 156g, and a second advice/modification factor value 154h with a second potential range change 156h. Other combinations of consumption factor values 152a-152g, modification advice items/modification factor values 154a-154h, and potential range changes 156a-156h may be implemented to meet a design criteria of a particular design.

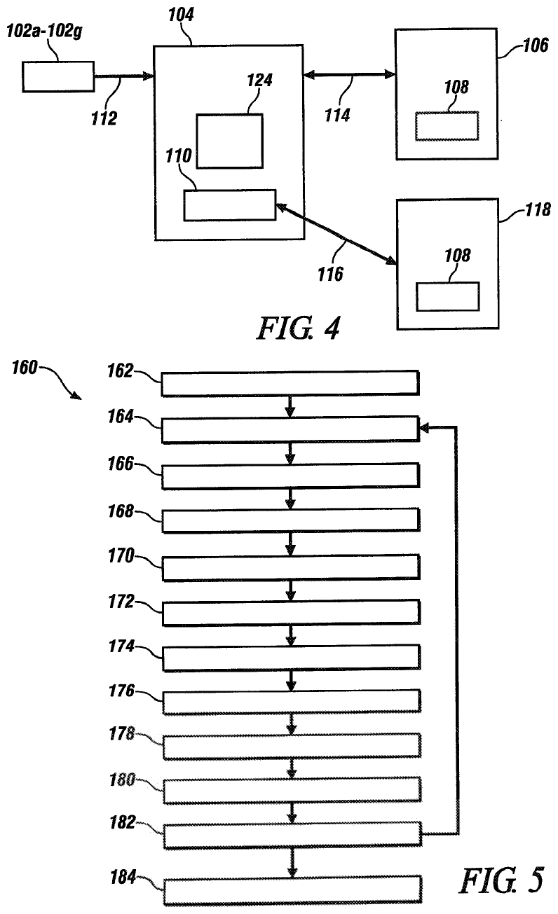

Referring to FIG. 4, a schematic block diagram of an example implementation of the advisory system 100 is shown in accordance with one or more exemplary embodiments. The circuit 104 generally includes a transceiver 110 and the sorted table 124. The circuit 104 communicates with the sensors 102a-102g via a bus 112. The infotainment system 106 communicates with the circuit 104 via a link 114 (e.g., wired or wireless). The handheld device 118 communicates with the circuit 104 via a link 116 (e.g., wired or wireless). A display 108 is provided in the infotainment system 106. Another display 108 is provided in the handheld device 118.

The transceiver 110 implements a transmitter and a receiver. The transceiver 110 is operational to provide bidirectional communication between the circuit 104 and the handheld device 118 via the link 116. In various embodiments, the transceiver 110 may be a radio-frequency transceiver and the link 116 is a wireless link. In other embodiments, the link 116 may be a wired link across which the transceiver 110 communicates with the handheld device 118.

The bus 112 implements an onboard communication bus. The bus 112 is operational to transfer the measured values from the sensor 102a-102g to the circuit 104. In various embodiments, the bus 112 implements one or more of a controller area network (CAN) bus, a WIFI bus, a Bluetooth bus, a Bluetooth Low Energy bus, a media oriented system transfer (MOST) bus, a local interconnection network, a local area network, an Ethernet bus, and/or other busses that conform with International Organization for Standardization (ISO), SAE International, and the like.

The link 114 implements a wired link and/or wireless link. The link 114 is operational to transfer the route plan screen 133 and the advice screen 132 to the infotainment system 106 for presentation on the infotainment system display 108. The link 114 may also convey manual inputs from the driver 82 back to the circuit 104 to configure the advisory system 100.

The link 116 implements a wired link and/or a wireless link. The link 116 is operational to transfer the advice screen 132 to the handheld device 118 for presentation on the handheld device display 108. Where the iteration block 122 (see FIG. 2) is implemented in the circuit 104, the link 116 transfer the navigation information from the handheld device 118 to the circuit 104. Where the iteration block 122 is implemented in the handheld device 118, the link 116 transfers the measurement data from the sensor 102a-102g through the circuit 104 to the handheld device 118. The link 116 may also convey manual inputs from the driver 82 back to the circuit 104 to configure the advisory system 100.

Referring to FIG. 5, a flow diagram of an example method 160 for generating economy driving advice is shown in accordance with one or more exemplary embodiments. The method (or process) 160 may be implemented by the advisory system 100. The method 160 includes steps 162 to 184, as illustrated. The sequence of steps is shown as a representative example. Other step orders may be implemented to meet the criteria of a particular application.

In the step 162 the circuit 104 receives a route plan of the vehicle 80. The step 164 defines a start of a periodic outer cycle. The sensors 102a-102g measure consumption factor values and the infotainment system 106/handheld device 118 measure a remainder of the route plan 130 in the step 166 while the vehicle 80 is moving. The circuit 104 receives the consumption factor values from the sensors 102a-102g, receives the remainder of the route plan 130, reads previous consumption factor values 152a-152g from historical records, and predicts future consumption factor values 152a-152g in the step 168.

In the step 170, the circuit 104 calculates a current range of the vehicle 80 based on the past and current consumption factor values, the remainder of the route plan, and predicts future consumption factor values. The sorted table 124 is populated with the potential range changes in the step 172. The sorted table 124 is arranged (or sorted) by the possible range changes in the step 174 with a furthest possible range change being an initial line in the sorted table 124, and a shortest possible range change being the last line in the sorted table 124.

In the step 176, the circuit 104 identifies a group that has one or more of the potential distances and a corresponding one or more of the plurality of modification factor values. The group is presented to the driver 82 in the step 178. The step 180 defines an end to the outer cycle. In the step 182 the circuit 104 may check to see if the vehicle 80 is still moving toward the ending location. If the vehicle 80 is still moving, the method 160 may periodically or repeatedly loop back to the start of the outer cycle in the step 164. Once the vehicle 80 has reached the ending location, or the driving assistance is no longer active, the method 160 may end in the step 184.

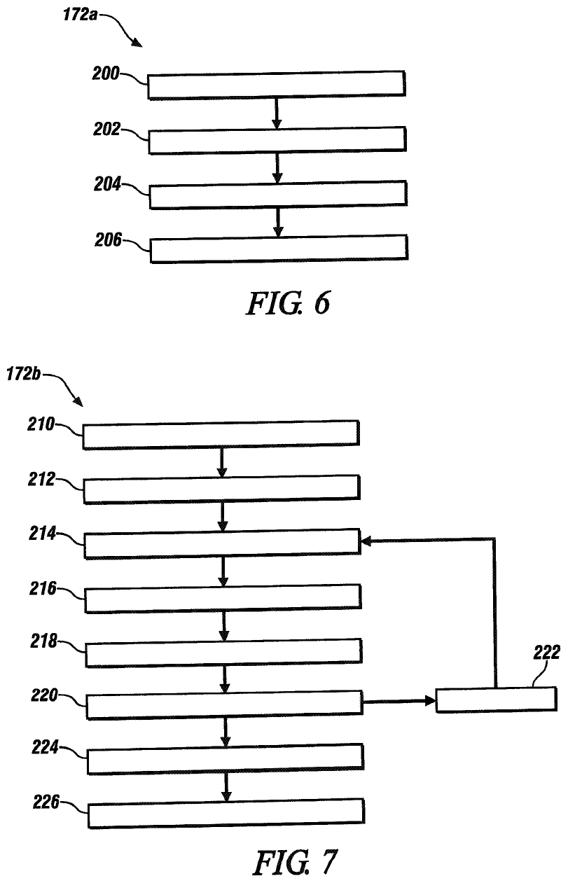

Referring to FIG. 6, a flow diagram of a first example implementation of the population of the sorted table step 172a is shown in accordance with one or more exemplary embodiments. The step 172a includes steps 200 to 206, as illustrated. The steps 200 to 206 may implement the step 172 in the method 160. The sequence of steps is shown as a representative example. Other step orders may be implemented to meet the criteria of a particular application.

In the step 200, the circuit 104 modifies the consumption factor values with the modification factor values to create the modified consumption factor values. The circuit 104 subsequently calculates the potential range changes of the vehicle 80 in the step 202 based on the route plan and the modified consumption factor values as if the driver 82 took the modification factor value/advice. In the step 204, the circuit 104 stores the potential range changes and corresponding modification factor value/advice in the sorted table 124. The first sorted table population step ends in the step 206.

Referring to FIG. 7, a flow diagram of a second example implementation of the population of the sorted table step 172b is shown in accordance with one or more exemplary embodiments. The step 172b includes steps 210 to 226, as illustrated. The steps 210 to 226 may implement the step 172 in the method 160. The sequence of steps is shown as a representative example. Other step orders may be implemented to meet the criteria of a particular application.

In the step 210 the circuit 104 may select a first subset (e.g., one or more) of the consumption factor values among the multiple consumption factor values to modify. The step 212 defines the start of an inner cycle. The first subset of the consumption factor values may be modified with a corresponding subset of the modification factor values in the step 214. In the step 216, the circuit 104 calculates a second subset of potential range changes of the vehicle 80 based on the remainder of the route plan, the unmodified consumption factor values, and the first subset of the modified consumption factor values. The potential range changes and the corresponding modification advice items/modification factor values are written 144 to and stored in the sorted table 124 in the step 218.

A check is performed in the step 220 for more consumption factor values that should be modified. If more consumption factor values are available to modify, a next subset of the unmodified consumption factor values is selected in the step 222. The step 224 defines an end of the inner cycle. The step 172b periodically loops back to the start of the inner cycle in the step 214 until the consumption factor values have been modified, one or more modifications per single pass through the inner cycle. Once the consumption factor values have been modified, the second sorted table population step ends in the step 226.

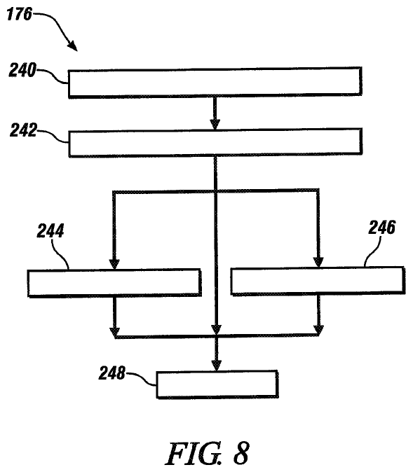

Referring to FIG. 8, a flow diagram of an example implementation of the identification of the group step 176 is shown in accordance with one or more exemplary embodiments. The step 176 includes steps 240 to 248, as illustrated. The sequence of steps is shown as a representative example. Other step orders may be implemented to meet the criteria of a particular application.

In the step 240, the circuit 104 may determine among a few possible group modes. The group mode may be selectable by the driver 82. The group modes may include a best mode where only the top predetermined number of the modification advice items/modification factor values is presented, a small mode where only modification advice item/modification factor value that lengthens the current range of the vehicle 80 is presented, and a full mode where the entirety of the modification advice items/modification factor values in the sorted table 124 is presented to the driver 82. The mode determination is made in the step 242. For the best mode, the group is created in the step 244 as the predetermined number of the potential range changes that starts from the longest potential range. The step 244 subsequently transitions to the step 248. For the small mode, the group is created in the step 246 as the potential range changes greater than the current range (e.g., positive range changes). The step 246 subsequently transitions to the step 248. For the full mode, the step 242 transitions directly to the step 248. The step 248 defines an end of the group identification step.

Various embodiments of the advisory system 100 provides drive-specific, quantitative real-time economy driving advice to the driver 82 of the vehicle 80. The advice may include actions regarding speed, accelerations, decelerations, HVAC, tire pressure, windows, and vehicle weight. The advisory system 100 combines information accessed through onboard computing with a vehicle energy predictor to quantify and propose energy saving actions. The real-time, energy saving display, are presented to the driver 82 in a simplified manner that may minimize distractions.

The economy advisory system 100 include a circuit 104 and a display 108 for a driver 82. The circuit 104 is configured to receive a route plan of the vehicle 80 and receive consumption factor values 152a-152g of the vehicle 80 while the vehicle 80 traverses the route plan 150a. The consumption factor values 152a-152g are controllable by the driver 82. The circuit 104 is also configured to modify the consumption factor values 152a-152g in the modification block 140, calculate potential range changes 156a-156h of the vehicle 80 based on the route plan 150a and the consumption factor values 152a-152g as modified, and identify a group that has at least one of the potential range changes 156a-156h and a corresponding at least one of the plurality of modification factor values 154a-154h. The display 108 is configured to present the group to the driver 82. The potential range changes 156a-156h educate the driver 82 on ways to improve the economy of the trip.

Numerical values of parameters (e.g., of quantities or conditions) in this disclosure, including the appended claims, are to be understood as being modified in each instance by the terms “about” and “approximately” whether or not “about” or “approximately” actually appears before the numerical value. “About” and “approximately” indicate that the stated numerical values allow some slight imprecision (with some approach to exactness in the value; about or reasonably close to the value; nearly). If the imprecisions provided by “about” and “approximately” are not otherwise understood in the art with this ordinary meaning, then “about” and “approximately” as used herein indicates at least variations that may arise from ordinary methods of measuring and using such parameters. In addition, disclosures of ranges include disclosures of each value therein and further divided ranges within the entire range. Each value within a range and the endpoints of a range are hereby disclosed as separate embodiments.

The claims may be drafted to exclude various elements. As such, this statement is intended to serve as antecedent basis for use of such exclusive terminology as “solely,” “only,” “at most” and the like in connection with the recitation of claim elements and/or use of “negative” limitations. As will be apparent to those of ordinary skill in the art, each individual embodiment described and illustrated herein has discrete components and features readily separated from or combined with the features of any of the other several embodiments without departing from the scope of the disclosure. Furthermore, recited method may be carried out in the order of events recited, or in other orders that are logically possible.

While the best modes for carrying out the disclosure have been described in detail, those familiar with the art to which this disclosure relates will recognize various alternative designs and embodiments for practicing the disclosure within the scope of the appended claims.

What is claimed is:

1. An economy advisory system comprising:
a circuit configured to:
receive a remainder of a route plan of a vehicle;
receive a plurality of consumption factor values of the vehicle while the vehicle traverses the route plan, wherein the plurality of consumption factor values is controllable by a driver of the vehicle;
modify the plurality of consumption factor values based upon a plurality of modification factor values;
calculate a plurality of potential range changes of the vehicle based on the remainder of the route plan and the plurality of consumption factor values as modified; and
identify a group that has at least one of the plurality of potential range changes and a corresponding at least one of the plurality of modification factor values; and
a display in communication with the circuit, and configured to present the group to the driver.

2. The economy advisory system according to claim 1, wherein the circuit is further configured to store the plurality of potential range changes and the plurality of modification factor values in a table prior to the identification of the group.

3. The economy advisory system according to claim 2, wherein:
the circuit is further configured to sort the plurality of potential range changes in the table from a furthest potential range change to a shortest potential range change; and
the group is identified as a predetermined number of the plurality of potential range changes as sorted that starts with the furthest potential range change.

4. The economy advisory system according to claim 1, wherein the circuit is further configured to repeat periodically in an inner cycle:
the modification of the plurality of consumption factor values; and
the calculation of the plurality of potential range changes.

5. The economy advisory system according to claim 4, wherein a first subset of the plurality of consumption factor values is modified and a second subset of the plurality of potential range changes is calculated in a single one of a plurality of passes through the inner cycle.

6. The economy advisory system according to claim 1, wherein the circuit is further configured to repeat periodically in an outer cycle:
the reception of the remainder of the route plan and the plurality of consumption factor values;
the modification of the plurality of consumption factor values; and
the identification of the group.

7. The economy advisory system according to claim 1, wherein:
the circuit is further configured to calculate a current range of the vehicle based on the route plan and the plurality of consumption factor values as measured; and
the group is identified as the plurality of potential range changes that increases the current range.

8. The economy advisory system according to claim 1, wherein:
the route plan is a plurality of possible route plans; and
the calculation of the plurality of potential range changes of the vehicle is based on the plurality of possible route plans and the plurality of consumption factor values as modified.

9. The economy advisory system according to claim 1, wherein the plurality of consumption factor values include one or more of a speed, an acceleration, a deceleration, a heating-ventilation-and-air conditioning set point, a tire pressure, a window position, and a weight of the vehicle.

10. A method for economy driving advice comprising:
receiving a remainder of a route plan of a vehicle at a circuit;
measuring a plurality of consumption factor values of the vehicle while the vehicle traverses the route plan, wherein the plurality of consumption factor values is controllable by a driver of the vehicle;
modifying the plurality of consumption factor values based upon a plurality of modification factor values;
calculating a plurality of potential range changes of the vehicle based on the remainder of the route plan and the plurality of consumption factor values as modified;
identifying a group that has at least one of the plurality of potential range changes and a corresponding at least one of the plurality of modification factor values; and
presenting the group to the driver at a display.

11. The method according to claim 10, further comprising:
storing the plurality of potential range changes and the plurality of modification factor values in a table prior to the identifying of the group.

12. The method according to claim 11, further comprising:
sorting the plurality of potential range changes in the table from a furthest potential range change to a shortest potential range change; and
wherein the group is identified as a predetermined number of the plurality of potential range changes as sorted that starts with the furthest potential range change.

13. The method according to claim 10, further comprising repeating periodically in an inner cycle:
the modifying of the plurality of consumption factor values; and
the calculating of the plurality of potential range changes.

14. The method according to claim 13, wherein a first subset of the plurality of consumption factor values is modified and a second subset of the plurality of potential range changes is calculated in a single one of a plurality of passes through the inner cycle.

15. The method according to claim 10, further comprising repeating periodically in an outer cycle:
the receiving of the remainder of the route plan;
the measuring of the plurality of consumption factor values;
the modifying of the plurality of consumption factor values; and
the identifying of the group.

16. The method according to claim 10, further comprising:
calculating a current range of the vehicle based on the route plan and the plurality of consumption factor values as measured; and
wherein the group is identified as the plurality of potential range changes that increases the current range.

17. The method according to claim 10, wherein:
the route plan is a plurality of possible route plans; and
the calculating of the plurality of potential range changes of the vehicle is based on the plurality of possible route plans and the plurality of consumption factor values as modified.

18. A vehicle comprising:
a plurality of sensors configured to measure a plurality of consumption factor values of the vehicle, wherein the plurality of consumption factor values is controllable by a driver of the vehicle;
a circuit in communication with the plurality of sensors, and configured to:
receive a remainder of a route plan of the vehicle;
receive the plurality of consumption factor values while the vehicle traverses the route plan;
modify the plurality of consumption factor values based upon a plurality of modification factor values;
calculate a plurality of potential range changes of the vehicle based on the remainder of the route plan and the plurality of consumption factor values as modified; and
identify a group that has at least one of the plurality of potential range changes and a corresponding at least one of the plurality of modification factor values; and
a display in communication with the circuit, and configured to present the group to the driver.

19. The vehicle according to claim 18, wherein:
the circuit is further configured to sort the plurality of potential range changes from a furthest potential range change to a shortest potential range change; and
the group is identified as a predetermined number of the plurality of potential range changes as sorted that starts with the furthest potential range change.

20. The vehicle according to claim 18, wherein:
the circuit is further configured to calculate a current range of the vehicle based on the route plan and the plurality of consumption factor values as measured; and
the group is identified as the plurality of potential range changes that increases the current range.
